(19) United States
(12) Patent Application Publication
(10) Pub. No.: US 2006/0115128 A1
(43) Pub. Date: Jun. 1, 2006

(54) Person recognition method and device

(76) Inventor: Jean-Francois Mainguet, Grenoble (FR)

Correspondence Address: LOWE HAUPTMAN GILMAN & BERNER, LLP, 1700 DIAGNOSTIC ROAD, SUITE 300, ALEXANDRIA, VA, 22314, US

(21) Appl. No.: 10/541,395

(22) PCT Filed: Jan. 16, 2004
(86) PCT No.: PCT/FR04/00093

§ 371 Date: Jul. 1, 2005

(30) Foreign Application Priority Data
Jan. 21, 2003 (FR) 03/00593

(51) Int. Cl. G06K 9/00

(52) U.S. Cl. 382/115

(57) ABSTRACT

The invention relates to the recognition of persons by biometric identification systems. According to the invention, for the recognition of persons, it is proposed to use an optical or other fingerprint image sensor 10 associated with spectral recognition of the skin using fewer light-emitting elements 12 than if the spectral recognition had been used on its own. The fingerprint image sensor and a sensor for spectral transmission information relating to the skin of the finger whose print is recorded by the image sensor are arranged on the same base.

The invention relates to biometric devices for the recognition of persons, intended for applications in which a high level of security is required against risks of fraud and/or in which the presence of a specific physical person and the reliable identification of this person are required in order to limit risks.

The device according to the invention uses a fingerprint image sensor. Such a fingerprint image sensor is produced using an integrated circuit, in principle based on silicon, comprising in particular a matrix of individual sensitive elements for establishing a representation of the image of the print of a finger placed directly or indirectly on the surface of the matrix. The detection of the print is in general optical or capacitive or thermal or piezoelectric, and the sensitive elements of the sensor are then respectively sensitive to light or capacitive proximity or heat or pressure.

Some sensors function in the presence of a finger placed statically on the surface of a sensor whose active detection matrix is rectangular or square; in this case, the surface of the sensor has an overall size corresponding to the print surface to be detected; other sensors function by sliding the finger over a sensor whose detection matrix, with a surface much smaller than the print to be detected, is an elongate bar of a few rows of point detectors (or even a single row).

The known techniques of fingerprint acquisition do not make it possible to detect whether the finger is living: the sensor can be deceived by using a molded false finger, but it is also possible to use a thin layer of plastic material on which a copy of the print is molded, this layer being adhesively bonded onto a genuine finger; the sensor can also be deceived, and this fraud is virtually impossible to detect, with a severed finger having a physiology extremely close to a finger normally connected to its original body.

A detection technique using two electrodes and measuring the conductivity or impedance of the finger has already been proposed, but is easily deceived by wetting a plastic false finger with the aid of saliva, or by using a conductive plastic material or even simply aluminum paper pressed against the false finger. This technique cannot be very accurate because the operating conditions can vary widely, and the finger of a given individual may have a very dry or very moist surface, which means that it is necessary to have a very wide acceptance zone for the measured impedance; a wide acceptance zone clearly facilitates fraud.

The detection of blood (pulse, oxygen level in hemoglobin) by optical means (light-emitting diode of suitable wavelength+photodiode) seems to offer a beneficial solution, but will be deceived by a film of transparent plastic material placed on a genuine finger, or by a plastic material having the appropriate “color” in the infrared. It is furthermore necessary to wait for at least one full heartbeat, which may take a fairly long time in the case of some athletes, and may therefore be inconvenient.

A recognition technique based on the shape of the heartbeat has already been proposed, but has not yet proven its performance; this performance will not be as accurate as that of fingerprints, and this technique has not provided any practical application to date.

Pulse measurement techniques are furthermore incompatible with the technique of scanning fingerprint acquisition as described in Patent FR 2 749 955, because the scanning time is of the order of half a second, which is much less than a heartbeat.

In the proposal of Patent US 2002/0009213, a spectral recognition technique for the skin, and more precisely the dermis, is proposed for the identification of persons. The accuracy of this technique has not yet been proven, and is not likely to be much more than that offered by the recognition of fingerprints. It requires illumination of the finger with a plurality of light-emitting diodes (LEDs) of various colors, and analysis of the light transmitted by the skin at various distances, using a number of photodiodes to measure the characteristics of this light: when the distance between the light emitter and the sensor is larger, commensurately deeper characteristics of the dermis will be obtained. Some frequency bands (toward the infrared) are furthermore very sensitive to the presence of blood. The number of photodiodes and light-emitting diodes will be limited by the fact that it is necessary to assemble them individually, and the associated cost therefore increases very rapidly.

For the recognition of persons, the present invention proposes to use an optical or other fingerprint image sensor (in principle on a silicon chip) associated with spectral recognition of the skin using fewer light-emitting elements (in general light-emitting diodes LED) than if the spectral recognition had been used on its own.

The invention therefore relates to a person recognition device having on the same base both a fingerprint image sensor and a sensor for spectral transmission information relating to the skin of the finger whose print is recorded by the image sensor.

For the spectral print, it is preferable but not obligatory to use light-emitting diodes, and a particular image will be obtained from each light-emitting diode with the aid of photodiodes detecting the light originating from these light-emitting diodes and transmitted through the finger; these diodes will preferably emit at a plurality of different wavelengths, particularly in the infrared, and the combination of these images will give rich information for recognition of the person because the skin (dermis and epidermis, but above all dermis) has spectral characteristics which vary from one individual to another. Detection photodiodes will preferably be arranged in a matrix in order to provide a set of spectral information similar to a spectral “print” specific to the individual.

Use of the fingerprint and spectral recognition of the skin will make it possible to obtain excellent recognition levels overall, and may in particular make it possible to recognize individuals for which fingerprint recognition is occasionally unsuitable.

This acquisition technique will be very difficult to forge with a false finger, because it would be necessary to have both the design of the print to be forged and knowledge of the internal structure of the skin of the finger of the individual to whom the print belongs, as well as the spectral characteristics of this skin.

The presence of blood will also be detected if a wavelength in the near infrared is used (particularly around 800 nm, which is the isosbestic point between oxyhemoglobin and hemoglobin), and this will be a strong element in the determination of a “living finger”.

The print image acquisition and the spectral information acquisition will be carried out either sequentially or simultaneously, the latter version being preferred. The acquisitions may also take place alternately: partial print image acquisition followed by partial spectral information acquisition, and another partial print image acquisition, etc., with the consistency of the various acquisitions being checked between the acquisitions or subsequently to the acquisitions.

The print image may be obtained statically or dynamically, in particular by optical, thermal or capacitive means. In static image acquisition, the finger remains immobile while the print is being read. In dynamic image acquisition or scanning acquisition, it is the finger which is moved over the sensor, or the sensor which is moved under a fixed finger; the overall image is reconstructed from partial images obtained using a sensor having only a small number of image point lines; the reconstruction is carried out by correlation between the partial images obtained successively during the relative movement.

The fingerprint image sensor is in principle based on a silicon chip.

The photodiodes for spectral information analysis are preferably located on the same chip as the fingerprint image sensor. The light-emitting diodes which provide the light source for obtaining spectral information are located off the silicon chip for technological reasons (they are not in principle produced using silicon).

For an equal quality level of the person recognition, the print sensor can be smaller than that which would be necessary without spectral recognition.

The light-emitting diodes and the photodiodes may be arranged symmetrically with respect to an axis in order to take a plurality of measurements equivalently at different positions: especially arrangements in two or four symmetrical sectors.

The photodiodes used for acquiring the spectral information may be the same as those which, in a matrix arrangement, are used for the print image acquisition.

The invention furthermore proposes to correlate the spectral information of the skin section being observed with a strip of fingerprint observed at the same time. This is because the spectral recognition makes it possible to deduce some parameters which will subsequently be accepted with a certain range in order to overcome the local variations of the skin. Depending on the position, identified with the aid of the fingerprint, it will be possible to check that the skin locally has the required characteristics, which relaxes the checking accuracy and makes the technique extremely difficult to forge.

This technique can be used in the case of static acquisition, but even more conveniently in the case of scanning acquisition which will make it possible to reduce costs (the silicon sensor will have a smaller area) while maintaining a large wealth of information.

The invention proposes that the fingerprint and spectral print acquisitions should preferably be carried out physically by the same photodiodes; the measurements will be taken sequentially or, preferably, simultaneously.

In the event that the fingerprint and spectral measurements are not simultaneous, whether or not they are carried out physically with the same photodiodes, the invention proposes to alternate the fingerprint acquisition and the spectral print acquisition in order to make fraud difficult. In fact, if the fingerprint were to be read then the spectral print were to be read after the end of the fingerprint reading, then it would potentially be possible to present a print forgery then a spectral forgery. If the sequence of measurements is sufficiently rapid or alternated, for instance reading a print sector, taking a spectral measurement with a first LED, then reading another sector, taking a second spectral measurement, etc. then fraud by alternately presenting a false fingerprint and a false spectral print becomes impossible.

Other characteristics and advantages of the invention will become apparent on reading the following detailed description, which is given with reference to the appended drawings in which:

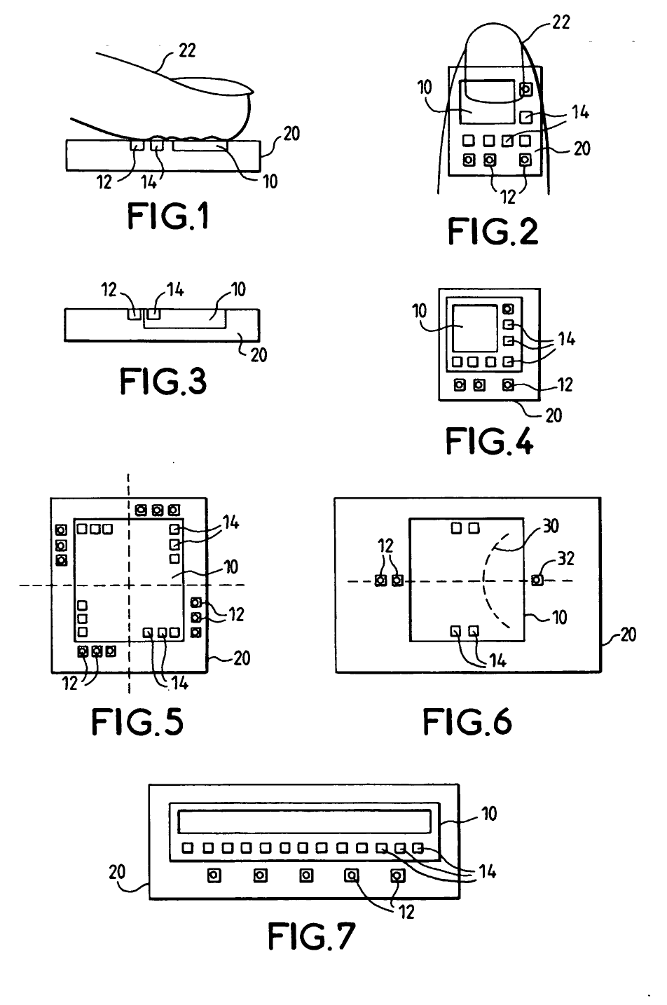

FIG. 1 represents the principle of the device according to the invention;

FIG. 2 represents a plan view of the device in FIG. 1;

FIG. 3 represents an embodiment with photodiodes integrated on the same chip as the print image sensor;

FIG. 4 represents a plan view of the sensor in FIG. 3;

FIG. 5 represents an embodiment of the sensor in four symmetrical sectors;

FIG. 6 represents an embodiment of the sensor in two symmetrical sectors;

FIG. 7 represents a sensor in which the image of the print is detected by moving the finger over the surface of the sensor.

In what follows, the abbreviation LED (“light-emitting diode”) will be used to denote the monochromatic or quasi-monochromatic light emitter for the spectral recognition, knowing that it will most often be a light-emitting diode but that it may be any type of light emitter suitable for this measurement (laser, white light plus filter, etc.). A plurality of colors are used, and therefore a plurality of diodes (or filters). The light emission is preferably in the red and near infrared ranges, for which there is not only good penetration of the light into the skin, but also good response from the blood and sufficient sensitivity of detectors produced using silicon.

The term photodiode is used to denote the light sensor which will convert the received photons into an electrical signal.

Acquisition of the spectrum of the skin requires measurement of the optical response of the skin to a light excitation for different optical wavelengths. It is necessary to avoid measuring the light reflected directly by the surface or the superficial layers of the skin (stratum corneum). This is because the information particular to each individual lies in the structure of the dermis. It is therefore necessary for the light emitter (LED) to be separated from the light sensor (photodiode) so that only the light which has passed through the skin reaches the sensor, while minimizing the fraction of light that can travel from the LED to the sensor directly or after simple reflection on the skin. The choice of the distance between the light emitter and the detector makes it possible to control the reduction of direct reflection.

FIG. 1 represents in section the principle of the invention, in which the fingerprint sensor and the spectral print sensor share the surface on which the finger presses during the person recognition operation. The (optical or other) print sensor is a matrix sensor consisting of a silicon chip mounted on a substrate 20. An LED 12 is represented together with a corresponding photodiode 14, which are mounted on the same substrate 20. In practice there will be a plurality of LEDs, preferably corresponding to different wavelengths, and a plurality of photodiodes.

The design is preferably such that the print sensor is significantly smaller than the finger, so that the skin can touch the spectral sensor at the same time in order to be able to take the acquisitions with a single “touch” by the user. The fact of having a smaller print sensor does significantly reduce the recognition performance, in particular due to the fact that it is difficult to present exactly the same part of a print each time. This loss of performance will be compensated for by the additional information provided by the spectral recognition.

FIG. 2 represents a plan view of the hybrid sensor with, in superposition, the image of the finger 22 placed on the sensor.

In order to reduce costs by reducing the total number of electronic elements to be combined, the choice will preferably be made to insert the photodiodes in the fingerprint sensor. It will be possible to do this in particular when the print sensor uses a silicon chip, on the surface of which the finger is placed directly. The chip should then be protected by a transparent (or perforated) surface protection layer which does not cover the photodiodes detecting the light from the LEDs.

FIG. 3 represents in section a basic embodiment having the photodiodes 14 incorporated with the silicon chip 10 constituting the fingerprint sensor. FIG. 4 represents a plan view of the configuration of the hybrid sensor in FIG. 3.

The LEDs will preferably be driven directly with the aid of the silicon chip 10, which can contain all the electronics required for the print detection and the spectral information detection.

It will also be possible to integrate the person recognition algorithm on the silicon chip, which will make the assembly even less expensive. This algorithm will most often consist in a comparison of current spectral measurements with a set of spectral measurements associated with an individual (simple comparison for checking identity) or a plurality of individuals (multiple comparison for identifying one person among several).

One advantage with the technique of integrating the diodes on the silicon print sensor is that it will be possible to provide numerous photodiodes for the spectral reading at an equal cost, because this cost depends essentially on the surface area of silicon rather than on the number of photodiodes, which is not the case when discrete elements are assembled.

Increasing the number of photodiodes for the spectral reading makes it possible to reduce the number of LEDs while increasing the accuracy of the measurement.

This furthermore permits correlation between the local spectral information and a particular zone of the finger, identified by the fingerprint: this will make it extremely difficult to fabricate a false finger, and will increase the accuracy of the identification. The photodiodes may be inserted in each sector which is intended to be characterized. Each sector may use its own set of LEDs in order to provide identical topological configurations and simplify the analysis, although it will also be possible to use a single set of LEDs for all the sectors. In this case, it will be beneficial to provide a configuration which is as symmetrical as possible. It will be desirable to use a guide for the finger in order to avoid rotations, which will simplify the correlation analysis.

FIG. 5 represents an embodiment in which the print sensor (silicon chip) is divided into four symmetrical zones each comprising a plurality of photodiodes, which are associated with LEDs arranged around the chip. FIG. 6 represents another embodiment with division of the sensor into two zones which are symmetrical with respect to a horizontal axis. The photodiodes are located on either side of this axis, in the chip, and the LEDs are preferably located on the axis, on each side of the chip.

In a particular embodiment in which the fingerprint detection matrix is a matrix of photodiodes (optical, static and direct-contact reading of the print), it is proposed that these same photodiodes should also be used for the spectral print detection. It will then be the LEDs which are used as an illumination source for illuminating the ridges and valleys of the fingerprints; the photodiodes collect a light pattern representing the fingerprint when all the LEDs are lit; in order to obtain spectral information, it is furthermore proposed that the LEDs should emit with different wavelengths. Typically, with a configuration such as that in FIG. 6 in which the LEDs are aligned on either side of the matrix of photodiodes along the horizontal symmetry axis of the matrix, it may be assumed that the photodiodes of the image detection matrix which lie on a circle arc 30 centered on a specific LED 32 receive spectral information originating from the same depth of dermis, constituting an element of the overall spectral recognition which can be obtained from the other LEDs. The different wavelengths of the LEDs and the different positions of the photodiodes in the matrix make it possible to define an overall spectral print.

In this embodiment, consequently, a plurality of LEDs of different wavelength will be placed around the static, direct-contact optical sensor. They will then have two uses: on the one hand, some or all of the LEDs will be lit simultaneously in order to illuminate the finger sufficiently to allow acquisition of the fingerprint with the aid of the matrix of photodiodes, which are connected to electronics suitable for this purpose. On the other hand, a single wavelength will be activated in order to make it possible to measure the spectral print with the aid of the same photodiodes, which are connected to electronics suitable for this spectral reading.

It will be possible to combine this arrangement of the photodiodes with the correlation analysis mentioned above.

In general, if the print acquisition and the spectral acquisition take place sequentially, a defrauder possessing a false fingerprint and a false finger having the correct spectral characteristics will be able to present each of the two imitations at the appropriate time. It is therefore highly desirable to make this very difficult, and the present invention proposes to alternate the readings and/or take the measurements several times: it will then be possible to ensure consistency of the information being read.

The various nonlimiting possibilities are as follows:

full reading of the print, then spectral reading, and then reading the print again, checking that both print images are identical (no movement between the two print readings);

partial reading of the print (for example the upper right fourth), partial reading of the spectral print (for example reading in the blue frequency band), and doing so sequentially until having fully read the other parts of the print sensor and the information corresponding to the other wavelengths;

reading the print in each frequency band, which allows simultaneous acquisition of the fingerprint and the spectral print.

Although it seems easier to use static acquisition of a fingerprint, in which the finger does not move while the information is being recorded, this does have the drawback of using an area of silicon at least equal to the size of the print being acquired.

The scanning acquisition technique in which the finger is slid over a linear acquisition zone has been proposed in Patent FR 2 749 955, the overall image being reconstructed from successive images partially overlapping one another. The invention is also applicable in this case. FIG. 7 represents a corresponding configuration of the hybrid sensor, with a silicon chip in the form of an elongate bar containing both a few lines of photodiodes for the print image acquisition and photodiodes for the spectral information acquisition, the light-emitting diodes being located outside the silicon chip.

When this scanning is used, the alternation of the readings as proposed above takes place naturally because the readings have to be taken “on-the-fly” (otherwise it would be necessary to pass the finger over two times, which significantly reduces the benefit of the technique).

An important improvement is provided by using the scanning technique in the fingerprint and spectral print correlation. This is because it will be possible to perform the correlations directly on the strips of the print, and specifically for a portion of skin in contact with the device at the time of the measurement. It will be possible to carry out a consistency check between the fingerprint corresponding to a finger sector and the spectral information corresponding to this sector for the person who is intended to be recognized.

It will also be possible to trigger the spectral analysis “on-the-fly” when a certain print section is detected, so that a well-defined part of the skin can be spectrally analyzed accurately.

It will furthermore be possible to perform correlations with a spatial (and temporal) offset, rather than directly, by evaluating the speed of the finger on-the-fly. The correlation may be performed over the same finger sector or over different sectors.

The preferred implementation of the invention will consist in using scanning optical print acquisition associated with the spectral print acquisition, in which the photodiodes are physically the same. This optimally reduces the elements required for the data acquisition, and therefore the costs.

It will be possible to separate the LEDs which are used as an illumination source for the print acquisition (by arranging them uniformly in order to illuminate the finger as well) from those which are used for the spectral image acquisition. Nevertheless it will be less expensive to share the use of the light-emitting diodes so that they fulfill both roles.

The following possibilities are also envisaged according to the present invention:

the light-emitting diodes may be integrated, to the extent which technology allows, in the chip constituting the fingerprint sensor;

the fingerprint sensor may be an optical sensor, although it may also be a capacitive, thermal, pressure or current flow sensor;

if the sensor is optical, the light source may be shared by the fingerprint acquisition and the spectral information acquisition;

for the spectral print acquisition, a wavelength may be used which serves to detect blood in the finger and/or the oxygen level in hemoglobin;

the finger may be guided by a finger guide in order to facilitate the correlation between the fingerprint acquisition and the spectral information measurements;

the device may be used one or more times for more reliable identification of a person: several fingers may be checked, or a fingerprint may be checked on one finger and the spectral information on another finger.

1-11. (canceled)

12. A person recognition device, comprising:
a scanning fingerprint image sensor on one base which acquires an image line or a small number of image lines;
means for reconstructing an overall print image by correlation between partial images obtained during a relative movement between the finger and the sensor, and
a sensor for spectral transmission information relating to the skin of the finger whose print is recorded by the image sensor, the image sensor and the spectral information sensor being designed to function alternately.

13. The device as claimed in claim 12, wherein the fingerprint image sensor is located on a silicon chip and the spectral transmission information sensor has light-emitting diodes and photodiodes.

14. The device as claimed in claim 13, wherein the photodiodes and the light-emitting diodes are located on the same chip as the print image sensor.

15. The device as claimed in claim 13, wherein the light-emitting diodes and the photodiodes are arranged symmetrically with respect to an axis.

16. A person recognition method, comprising the steps of:
detecting both a fingerprint image and spectral transmission information relating to the skin of a finger whose print using the same devices, which has a scanning print image sensor and a spectral transmission information sensor, recognizing the person using both the print image and the spectral transmission information,
acquiring using the image sensor g an image line or a small number of image lines and reconstructing an overall print image by correlation between partial images obtained during a relative movement between the finger and the sensor, the print image sensor and the spectral information sensor functioning alternately.

17. The method as claimed in claim 16, wherein the full fingerprint is read several times and the full spectral information is collected several times, alternately, and the consistency between the different detected information is checked.

18. The method as claimed in claim 16, wherein a part of the fingerprint corresponding to a specific finger sector is read, the spectral information corresponding to this sector is read, and a full image of the print is subsequently reconstructed from the partial images.

19. The method as claimed in claim 18, comprising checking that the fingerprint corresponding to a finger sector is consistent with the spectral information corresponding to this sector or to another sector for the person who is intended to be recognized.

20. The device as claimed in claim 12, wherein the print sensor is an optical or capacitive or thermal sensor or a sensor sensitive to the flow of current through the finger, or a sensor sensitive to pressure.

21. The device as claimed in claim 12, wherein the same light source is used both for the fingerprint acquisition and for the spectral information acquisition.

22. The device as claimed in claim 12, wherein the spectral information acquisition comprises a measurement at a wavelength used for the detection of blood and/or the oxygen level in hemoglobin.

23. The device as claimed in claim 14, wherein the light-emitting diodes and the photodiodes are arranged symmetrically with respect to an axis.
